(19) United States
(12) Patent Application Publication
(10) Pub. No.: US 2021/0084840 A1
(43) Pub. Date: Mar. 25, 2021

(54) TURF REPAIR TOOL

(71) Applicant: FORTHROOTS LIMITED, Dunfermline Fife (GB)

(72) Inventor: Blair Young, Dunfermline Fife (GB)

(73) Assignee: FORTHROOTS LIMITED, Dunfermline Fife (GB)

(21) Appl. No.: 16/635,437

(22) PCT Filed: Jul. 30, 2018
(86) PCT No.: PCT/GB2018/052156

§ 371 Date: Jan. 30, 2020

(30) Foreign Application Priority Data
Jul. 31, 2017 (GB) 1712258.1

(51) Int. Cl. A01G 20/30; A63B 57/50; A01C 5/02; A01C 7/02

(52) U.S. Cl. CPC A01G 20/30; A01C 7/02; A01C 5/02; A63B 57/50

(57) ABSTRACT

An apparatus and method for repairing areas of damage on sports turf, and in particular a turf repair tool which can be used to repair pitch marks, blemishes and other areas of damage, for example on golf greens, by creating a seed bed using a first end of the turf repair tool and dispensing seed into the seed bed from a second end of the turf repair tool. The first end of the turf repair tool can create a seed bed of a predetermined size and shape and the second end of the turf repair tool can dispense a calibrated or predetermined amount of seed into the seed bed, allowing for optimal plant growth. Optionally, the turf repair tool can level the playing surface and/or protect the seed by dispensing coloured sand over the seed bed after the seed has been dispensed.

The present invention relates to an apparatus and method for repairing areas of damage on sports turf, and in particular to a turf repair tool which can be used to repair pitch marks on golf greens.

### BACKGROUND TO THE INVENTION

Pitch marks are a common problem on golf greens. Pitch marks resemble small craters and are created when a golf ball strikes the surface of the green, forcing material including grass and soil away from the point of impact, often exposing bare soil or rootzone. On firmer surfaces, the pitch marks tend to take the form of ‘burns’ where rather than a crater being created, the ball bruises the grass leaf, leaving it vulnerable to wind burn and/or heat damage and ultimately the death of the plant.

Proper pitch mark repair normally involves the use of a small pitch fork, a typically two-pronged device, which is inserted into the turf around the pitch mark and used to move the displaced material (including the grass) back towards the middle of the pitch mark by pushing the top of the pitch fork towards the middle of the pitch mark. This is repeated around (and sometimes within) the pitch mark until it is effectively filled back in with the displaced material, then the material is lightly tapped down with the bottom face of a putter or the players foot. Pitch marks repaired in this way may heal in 24 to 48 hours.

However, it is not uncommon for inexperienced (or even experienced golfers) to incorrectly attempt to repair pitch marks; a common mistake is to insert the pitch fork into the turf and pull the top of the pitch fork away from the middle of the pitch mark. While this gives the appearance of repairing the playing surface what actually happens is that the area is left without any healthy grass and the rootzone is pushed up from the base of the pitch mark to the surface which also smothers plants surrounding the damaged area. This area may bald as a result, or may create a space for undesirable species to fill. It may take 2 to 4 weeks for such damage to heal and in severe cases even longer.

Nonetheless, even if proper pitch mark repair is carried out the pitch mark will often have created a space in the sward which an undesirable species may fill. For example, there is a high likelihood of annual meadow grass (which is considered a weed species) invading the playing surface and this is not a grass which is particularly desirable for golf green management. Finer grasses such as bents and fescues are preferred as they tend to provide improved playing surfaces.

Routine repair and maintenance of golf greens generally involves overseeding to fill in damaged or thinned areas of grass. This is particularly important because the grass is typically kept too short to self-seed. Thatch must first be removed, then the seedbed prepared by, for example, deep scarifying or hollow tining. Seed and topdressing is then applied across and worked into the entire surface. Such processes typically use large machines, at least for thatch removal and seedbed preparation and are unsuitable for spot repairs. Tractor mounted spreaders and drop spreaders may be necessary for larger surface areas. This can be quite a wasteful process as not all of the seed which is laid down will germinate. Furthermore, the green is unplayable during such maintenance.

There is generally a need for an apparatus and method which addresses one or more of the problems identified above.

It is amongst the aims and objects of the invention to provide an apparatus and method for turf repair and which obviates or mitigates one or more drawbacks or disadvantages of the prior art.

In particular, one aim of an aspect of the invention is to provide an apparatus and method that enables pitch marks to be repaired in such a manner that undesirable species are prevented from invading the playing surface. Another aim of an aspect of the invention is to improve the quality of playing surfaces in general by facilitating and hence encouraging spot repairs of pitch marks, blemishes and other areas of damage.

Further aims and objects of the invention will become apparent from reading the following description.

### SUMMARY OF THE INVENTION

According to a first aspect of the invention, there is provided a turf repair tool, the turf repair tool comprising a body, a first end comprising a seed bed creation portion, and a second end comprising a seed dispensing portion, wherein the seed bed creation portion is configured to create a seed bed in an area of turf and the seed dispensing portion is configured to dispense seed into the seed bed created by the seed bed creation portion.

The above invention provides a single tool which can create a seed bed in an area of turf, for example in an area of damage such as a pitch mark, and subsequently dispense seed into that created seed bed.

Preferably, the seed bed creation portion comprises a surface which protrudes from the tool by a predetermined distance.

Preferably, the seed bed creation portion comprises at least one boss or protrusion. The at least one boss or protrusion may be conical. Alternatively, the at least one boss or protrusion may be prismatic. The seed bed creation portion may comprise an array of bosses or protrusions.

Preferably, the seed bed creation portion comprises a seed bed creation module which is removably attached to the body. This may be by way of a screw attachment or a push fit arrangement.

Alternatively, the seed bed creation portion and the body comprise a substantially unitary construction.

Preferably, the turf repair tool comprises a seed storage volume. This may be located within the body.

Preferably, the seed dispensing portion is configured to dispense a predetermined amount of seed into the seed bed.

The seed dispensing portion may comprise a seed receptacle which is moveable between a first position in which seed from the seed storage volume is collected in the seed receptacle and a second position in which the seed is dispensed from the seed receptacle. Preferably, in the second position the receptacle is coincident with an aperture in the seed dispensing portion.

Preferably, the seed receptacle is sized to collect the predetermined amount of seed from the seed storage volume. The seed receptacle may comprise a radial bore extending through an actuator.

Preferably, the receptacle is biased towards the second position. This may be achieved by use of a spring or similar device to bias an actuator in which the seed receptacle is formed.

The seed dispensing portion may comprise a hopper to direct seed from the seed storage volume towards the seed receptacle.

Optionally, the seed dispensing portion comprises a shape corresponding or complementary to the shape of the seed bed creation portion. Optionally, the seed dispensing portion comprises a protrusion, which may be conical or frustoconical in shape. The shape of the protrusion may allow the seed to be directed onto or into the seed bed when dispensed. Alternatively, the seed dispensing portion comprises a recess, which may be conical or frustoconical in shape. The recess may act as a wind shield when dispensing seed. The shape of the recess may permit or cause the seed to spread out over the seed bed when dispensed.

Preferably, the seed dispensing portion comprises a seed dispensing module which is removably attached to the body.

Alternatively, the seed dispensing portion and the body comprise a substantially unitary construction.

Optionally, the turf repair tool further comprises a sand dispensing portion. Preferably, the sand dispensing portion comprises a sand storage volume. This may be located within the body.

Preferably, the sand dispensing portion comprises an aperture. Preferably, the sand dispensing portion comprises a cover for the aperture.

Optionally, the sand dispensing portion is located between the seed bed creation portion and the seed dispensing portion. Alternatively, the sand dispensing portion may be integral to the seed bed creation portion.

According to a second aspect of the invention there is provided a method of repairing turf, the method comprising creating a seed bed, wherein the seed bed is created and the seed dispensed into the seed bed using a turf repair tool according to the first aspect.

Preferably, the method comprises pushing the first end of the turf repair tool into the turf to create the seed bed. The method may optionally comprise selecting a seed bed creation module appropriate for the turf to be repaired and/or the seed to be dispensed.

Preferably, the method comprises dispensing seed into the seed bed from the seed dispensing portion. The method may optionally comprise selecting a seed dispensing module appropriate for the seed to be dispensed, and may optionally comprise selecting a seed type appropriate for the turf to be repaired and storing the seed in a seed storage volume of the turf repair tool.

Optionally, the method further comprises dispensing coloured sand onto the turf from a sand dispensing portion of the turf repair tool. The method may optionally comprise selecting a sand of a colour appropriate for the turf to be repaired and storing the sand in a sand storage volume of the turf repair tool. Preferably the coloured sand is dispensed onto the turf after the seed has been dispensed into the seed bed. The coloured sand may be used to level the playing surface and/or protect the seed.

Preferably, the method comprises repairing a pitch mark on the turf using a pitch fork or similar pitch mark repairer prior to creating the seed bed and dispensing the seed into the seed bed.

Embodiments of the second aspect of the invention may comprise features corresponding to the preferred or optional features of the first aspect of the invention or vice versa.

### BRIEF DESCRIPTION OF THE DRAWINGS

There will now be described, by way of example only, various embodiments of the invention with reference to the drawings (like reference numerals referring to like features), of which:

FIG. 1 is a first perspective view of a turf repair tool having a seed bed creation portion or module and a seed dispensing portion or module;

FIG. 2 is a second perspective view of the turf repair tool in FIG. 1;

FIG. 3 is a perspective view of an alternative seed bed creation portion or module to that shown in FIG. 1;

FIG. 4 is a perspective view of an alternative turf repair tool;

FIG. 5 is a cross-sectional view of an exemplary seed dispensing portion or module;

FIG. 6 is a perspective view of another alternative turf repair tool; and

FIG. 7 is a perspective view of a further alternative turf repair tool.

### DETAILED DESCRIPTION OF PREFERRED EMBODIMENTS

As discussed in the background to the invention above, even when proper pitch mark repair techniques are applied there remains a risk that the damage will not heal properly and in some cases that invasive or otherwise undesirable grass or plant species may infiltrate the playing surface. There is also an issue that the playing surface is compromised, physically and aesthetically, until it has healed.

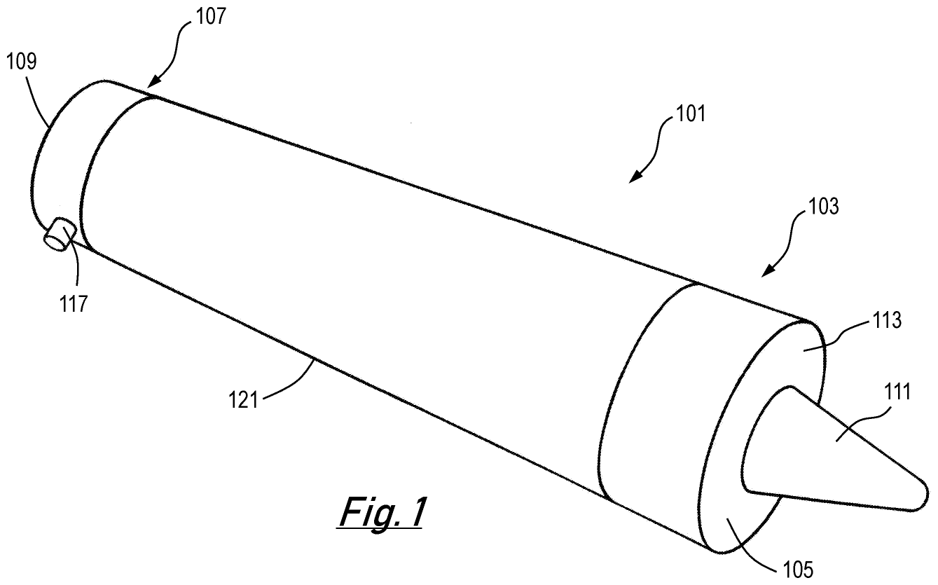

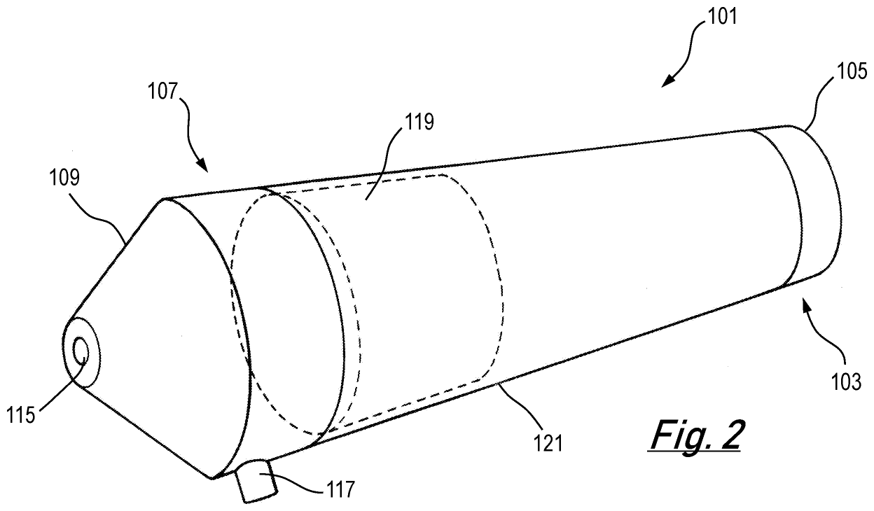

An embodiment of the present invention is illustrated in FIGS. 1 and 2 and overcomes these problems with the prior art. A turf repair tool 101 is shown which can be seen to comprise a first end 103 at which there is located a seed bed creation portion 105, and a second end 107 at which there is located a seed dispensing portion 109.

The seed bed creation portion 105 comprises a conical boss 111 and defines a shoulder 113 such that, when oriented at least substantially vertically and pressed down into the ground, a seed bed of corresponding shape and size is created in the ground. The shape and size of the boss 111 is selected so as to produce a predetermined seed bed which is of a suitable depth to receive desirable grass species.

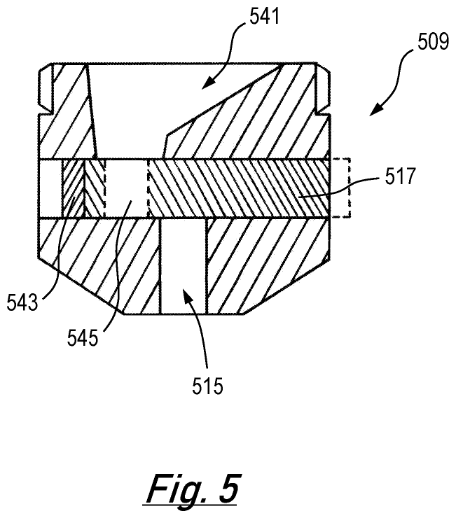

The seed dispensing portion 109 comprises an aperture 115 and an actuator 117 by which a predetermined, measured or calibrated volume of grass seed can be dispensed into the seed bed created by the boss 111. An exemplary but non-limiting example of a suitable dispensing arrangement is described further below with reference to FIG. 5.

The predetermined, measured or calibrated volume of seed provides sufficient seed to increase the likelihood of germination whilst avoiding waste. Furthermore, by placing the seed at the correct depth by virtue of the seed bed created by the conical boss 111, the chances of germination are further increased and the risk of the seeds blowing away or being eaten by birds are greatly reduced.

Within the tool 101 is located a seed storage volume 119, indicated schematically in FIG. 2. This seed storage volume 119 accommodates enough seed for several repairs to be carried out.

The first 103 and second 107 ends of the turf repair tool 101 are separated by a cylindrical body 121 which is conveniently sized for the hand of a user. The body 121 may be of any suitable length, but it will be apparent that a larger or longer body will accommodate a larger seed storage volume 119, whereas a smaller or shorter body will be easier to store, say, in a user's pocket.

The seed bed creation portion 105 and the seed dispensing portion 109 are, in this embodiment, attached to the body 121 by screw threads and therefore may be removed from the body 121. Different seed bed creation portions and different seed dispensing portions may be attached in their places. In this sense, the portions 105,109 may be referred to as modules.

By way of example, two of the most preferred grass species are fescue and bent grass. Fescue seeds are relatively large and it is expected that they will do well (in a pitch repair situation) if 1-5 seeds are buried at a depth of 12-15 mm. Accordingly, a suitable seed bed creation portion or module might comprise a conical boss with a length of, say, 12-15 mm, and a suitable seed dispensing portion or module might be configured to dispense 1-5 seeds from the seed storage volume.

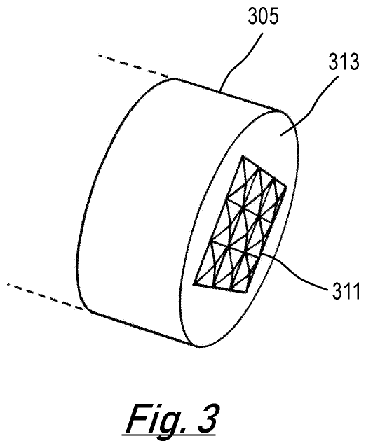

Bent seeds by comparison are very small and it is expected that they will do well if approximately 20 seeds are buried at a depth of 1-2 mm. This is obviously shallower than required for fescue; accordingly the above described fescue seed bed creation portion or module may not be suitable for bent seed. A suitable seed bed creation portion might comprise a conical boss with a length of 1-2 mm. Alternatively, the seed bed creation portion or module might comprise a shaped surface such as an array of conical bosses, prisms or prism-like structures which protrude about 1-2 mm. Such an alternative seed bed creation portion or module 305 is illustrated in FIG. 3. Similarly, a suitable seed dispensing portion or module might be configured to dispense approximately 20 seeds from the seed storage volume.

The skilled person will understand that the depths and amounts above are for the purposes of illustration only and are non-limiting even in embodiments specifically configured for fescue and bent seed. Optimal depths will depend on a number of parameters including the type and quality of soil and drainage conditions, and thus may vary from course to course. It will also be understood that the size and shape of the seed bed creation portion or module can be designed to suit the particular seed and/or environment, and the conical boss and prismatic surfaces (which might cover the whole surface or just a part as shown in FIG. 3) described above are but two non-limiting examples.

The described features enable the tool to create a suitable environment for seeds to be planted in the ground as well as to dispense an appropriate amount of seed into that environment, and furthermore combines these in a single device which has modules which can be exchanged to suit and accommodate different grass species.

In the embodiment described above (and the embodiment described below), the modular portions 105, 109 are removably attached to the main body 121 by screw threads. Any other suitable attachment arrangement may be employed, for example a push fit engagement. However, it is also foreseen that the body and the seed bed creation portion and/or the seed dispensing portion may comprise an at least substantially unitary construction. In such case, different turf repair tools, with appropriately sized and shaped seed bed creation portions and suitably configured seed dispensing portions, can be provided for different seed types.

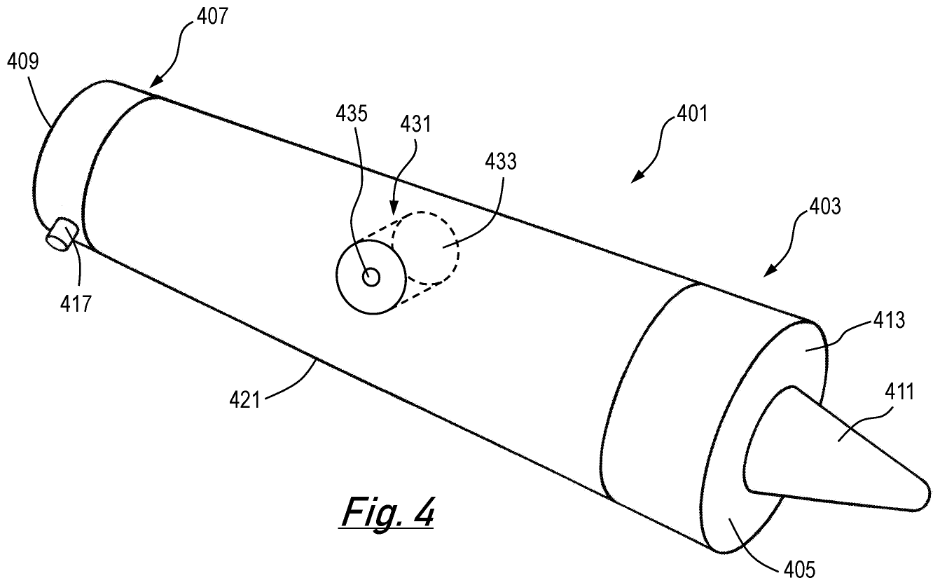

An alternative embodiment of the present invention is illustrated in FIG. 4. The turf repair tool 401 shares all of the features of the turf repair tool 101 illustrated in FIG. 1. However, turf repair tool 401 further comprises a sand dispenser portion 431 which is disposed in the body 421 of the tool 401. The sand dispenser portion 431 comprises a sand storage volume 433 within the body 421 of the tool 401, and an aperture 435 through which sand can be dispensed. A cover (not shown) is provided to cover the aperture and prevent spillage.

In use, the sand dispenser portion 431 is intended to store and dispense coloured sand so as to permit short term cosmetic improvement to the pitch mark (or other damage) repaired using the tool 401. By dispensing a thin layer of green coloured sand over the repaired pitch mark the appearance of the green is improved while the seeds germinate underneath, and the seeds are further prevented from being blown away or eaten by birds. This also levels and thereby (at least temporarily) improves the playing surface.

It will be understood that the position of the sand dispenser portion within the tool 401 can be changed without altering its function which is to dispense coloured sand (or other dressing) onto the repair which has just been carried out using the seed bed creation portion or module and the seed dispensing portion or module. It may be located closer to the seed bed creation portion or module or it may be located closer to the seed dispensing portion or module.

It is also envisaged that it may be integrated with the seed dispensing portion or module for dispensing coloured sand from the same end of the tool. The actuator or button may operate in a two stage manner, a first stage of which dispenses seed and a second stage of which dispenses coloured sand—or separate actuators or buttons may be provided for seed and coloured sand. However, it is preferable that the sand dispensing portion be separate such that a user can have control over how much coloured sand is dispensed—larger pitch marks (e.g. pits or skid marks) may require more coverage than a small bruise or dent.

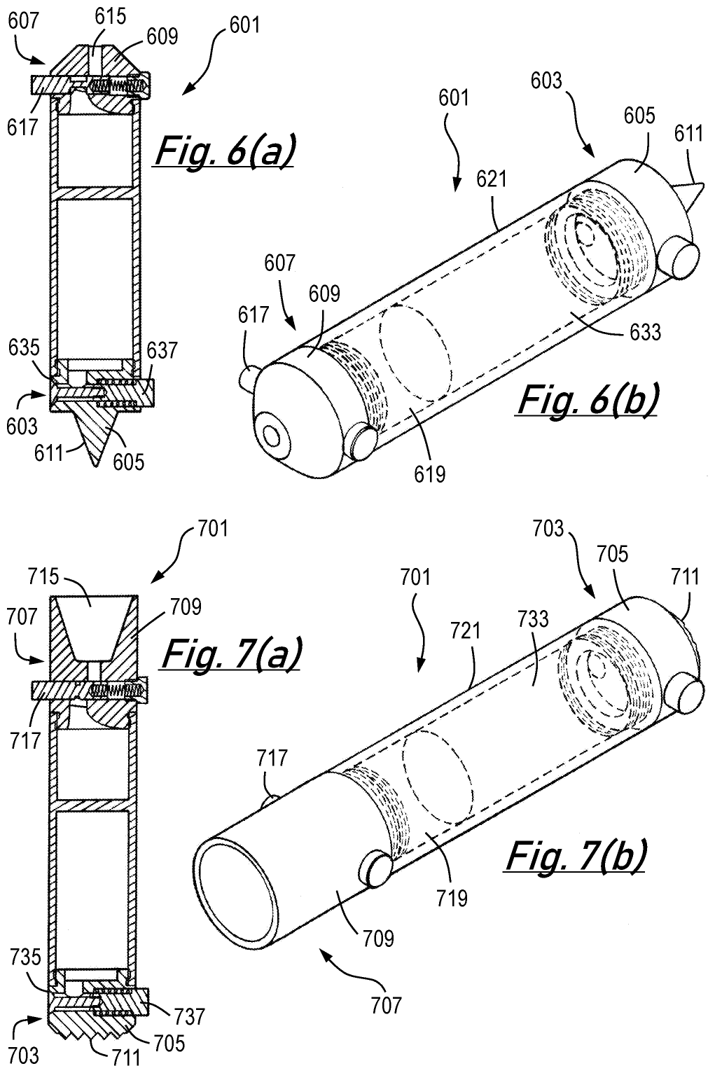

In an alternative embodiment (see discussion of FIGS. 6 and 7 below for example) the sand dispensing portion may be integrated with the seed bed creation portion, in which case the seed bed creation portion may be provided with an aperture and/or an actuator or button to permit selective and controlled dispensing of coloured sand, for example from the side of the seed bed creation portion. In use the seed bed creation portion can be used to create the seed bed, the tool inverted to dispense the correct amount of seed in the seed bed, then inverted again to dispense the coloured sand. This arrangement and the required inversions during use may avoid accidentally dispensing sand before dispensing seed.

Different coloured sands can be used to effectively colour match to the existing playing surface, and this might be particularly effective for televised events where colour differences across a playing surface might be more perceptible.

FIG. 5 illustrates in schematic form a cross-section through a seed dispensing portion or module 509 such as comprised in the turf repair tools illustrated in FIGS. 1 and 4. There is provided a hopper 541 which is in communication with the seed storage volume and, under gravity, guides seed towards a seed receptacle 545 into which the seed falls when actuator 517 is depressed (as shown). The seed receptacle 545 is a continuous radial bore and is sized to accommodate a predetermined amount of seed (as discussed above). The actuator 517 is biased outwards by a spring 543 such that when released the actuator is pushed away and the receptacle 545 moves toward the aperture 515, whereupon the seed in the receptacle 545 falls under gravity out of the aperture 515. In summary, pressing the actuator 517 in once and releasing it dispenses a predetermined or calibrated amount of seed. The receptacle 545 can be made larger or smaller to dispense more or less seed, respectively. In its default position, the receptacle 545 is coincident with the aperture 515 such that there is no seed contained in the receptacle 545 unless the actuator 517 is depressed.

The material from which the turf repair tool is formed or manufactured is unimportant, but it is preferred that it comprise stainless steel or aluminium for example. In an embodiment of the invention the turf repair tool may comprise a substantially unitary body. In an alternative embodiment, the turf repair tool may comprise (as noted above; see also discussion of FIGS. 6 and 7 below) a body of a first relatively light material (for example acrylic, polypropylene, polyethylene or polyvinyl chloride) and removable/replaceable seed bed creation and seed dispensing portions of a second material such as stainless steel or aluminium, although there is no reason why the body could not comprise such a material nor why the seed bed creation and seed dispensing portions could not comprise a relatively light material as well.

FIGS. 6 and 7 illustrate (in (a) cross section and (b) perspective views) similar but further alternative embodiments of a turf repair tool 601,701 according to the present invention. In fact, as seed bed creation portions 605,705 and seed dispensing portions 609,709 are removably attached to body 621,721 it will be readily apparent that the same body might be used and seed bed creation portions and seed dispensing portions interchanged in a modular manner. For example, the embodiment shown in FIG. 6 may be particularly suited for fescue grass seed, whereas the embodiment shown in FIG. 7 may be particularly suited for bent grass seed.

In any case, similarly to the embodiments shown in FIGS. 1 to 5, the tools 601,701 each comprise a cylindrical body 621,721, a first end 603,703 at which there is located a seed bed creation portion 605,705, and a second end 607,707 at which there is located a seed dispensing portion 609,709. Within the body 621,721 is provided a seed storage volume 619,719 in communication with the seed dispensing portion 609,709.

In FIG. 6, the seed bed creation portion 605 comprises a conical boss 611 similar to the conical bosses 111,411 shown in FIGS. 1 and 4, and in FIG. 7 the seed bed creation portion 705 comprises an array of relatively short prismatic structures 711 similar to those shown in FIG. 3. However, in contrast to the embodiment shown in FIGS. 1 to 5, a sand dispensing portion is integral to the seed bed creation portion 605,705. The sand dispensing portion is in communication with a sand storage volume 633,733 within the body 621,721 of the tool 601,701, and comprises an actuator 637,737 which allows selective or controllable dispensing of coloured sand from an outlet 635,735 which is biased closed.

In each tool 601,701 the seed dispensing portion 609,709 is of a different configuration. The seed dispensing portion 609 of tool 601 is similar to those shown particularly in FIGS. 2 and 5, having a conical protrusion and an actuator 617 which selectively dispenses seed from the seed storage volume 619. While seed dispensing portion 709 similarly selectively dispenses seed from the seed storage volume 719 by way of actuator 717, the shape of the seed dispensing portion 709 is quite different. The seed dispensing portion 709 is cylindrical with a conical or frusto-conical recess 715 which diverges away from the body 721 of the tool 721. This recess 715 has the advantage that it helps (or simply allows) the seed to spread out when it is dispensed to cover the corresponding seed bed. It has the further advantage that it protects the seed from wind as it is dispensed so that it goes into the seed bed and isn't blown away.

It should be noted that the present invention is not intended to negate the need for proper pitch mark repair; rather the present invention is intended to supplement proper pitch mark repair and thereby improve the chances of successful recovery thus increasing the health, appearance and playing quality of golf greens.

When repairing a pitch mark in accordance with the present invention, standard pitch mark repair methodology should be followed whereby a pitch fork (or equivalent tool) is used to move displaced material back towards the middle of the pitch mark. A “pit” or “skid mark” type of pitch mark might require a lot more attention than a “dent”, but the intention is to return the playing surface to its original condition (as much as possible).

After the standard pitch mark repair methodology has been applied, the first end of a turf repair tool according to the present invention is then pushed into the area of the pitch mark thus creating a seed bed of a predetermined depth. The turf repair tool is then inverted and a predetermined amount of seed dispensed into the seed bed. The user may then apply a thin layer of coloured sand over the area of the pitch mark to cover the seeds (if the repair tool used has this optional feature) and if necessary level the playing surface.

It should also be noted that while the present invention has been described in the context of repairing pitch marks of the kind which may be referred to as “pits” or “skid marks”, it may also be used to repair less obvious areas of damage of the kinds which may be referred to as “bruises” or “dents”. Dents may be repaired in the same way as pits; firstly with light use of a pitch fork (or equivalent tool) then by application of the turf repair tool. Bruises, which may be more common on harder greens such as may be found on the links courses of Scotland, England and Ireland, may also be repaired in the same way, or alternatively just by application of the turf repair tool.

Similarly, it is also envisaged that the present invention may be used for spot repairs, for example to overseed small areas of damage where incorrect pitch repair has been performed in the past and an area of scarring has been left on the playing surface. For example, if a pitch mark has been repaired incorrectly there may be an area of turf where there is no grass or where the grass is wilted or yellowed or even where an undesirable species has infiltrated the playing surface. The turf repair tool can be used to create a suitable seed bed in the relevant area and subsequently seed the area with desirable grass species. The turf repair tool can also be used to repair other blemishes that can appear on fine turf due to, for example, disease or removal of moss.

It is to be expected that proactive use of the turf repair tool on new pitch marks as well as older areas of damage will result in widespread improvement of playing surfaces and resulting increased enjoyment and consistency for players. Anecdotally, it is believed that courses which encourage players to repair existing pitch marks as well as their own have led to greatly improved playing surfaces. Furthermore, continual management of small areas will, over time, improve greens overall by increasing the coverage of desirable grass species.

The invention provides an apparatus and method for repairing areas of damage on sports turf, and in particular a turf repair tool which can be used to repair pitch marks, blemishes and other areas of damage, for example on golf greens, by creating a seed bed using a first end of the turf repair tool and dispensing seed into the seed bed from a second end of the turf repair tool. The first end of the turf repair tool can create a seed bed of a predetermined size and shape and the second end of the turf repair tool can dispense a calibrated or predetermined amount of seed into the seed bed, allowing for optimal plant growth. Optionally, the turf repair tool can level the playing surface and/or protect the seed by dispensing coloured sand over the seed bed after the seed has been dispensed.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers. Furthermore, relative terms such as “up”, “down”, “top”, “bottom”, “upper”, “lower”, “upward” and “downward” may be used herein to indicate directions and locations as they apply to the appended drawings and/or described applications and will not be construed as limiting the invention and features thereof to particular arrangements or orientations. For example, the term “down” is generally intended to mean in the direction of the turf to be repaired, and “bottom” is generally intended to mean closest to the turf to be repaired.

Various modifications to the above-described embodiments may be made within the scope of the invention, and the invention extends to combinations of features other than those expressly claimed herein.

1. A turf repair tool, the turf repair tool comprising a body, a first end comprising a seed bed creation portion, and a second end opposite the first end comprising a seed dispensing portion, wherein the seed bed creation portion is configured to create a predetermined seed bed in an area of turf and the seed dispensing portion is configured to dispense a predetermined amount of seed into the seed bed created by the seed bed creation portion, wherein the seed bed creation portion comprises at least one boss or protrusion which protrudes from the tool by a predetermined distance to create a seed bed of a predetermined depth.

2.-3. (canceled)

4. The turf repair tool of claim 1, wherein the at least one boss or protrusion is conical or prismatic.

5. (canceled)

6. The turf repair tool of claim 1, wherein the seed bed creation portion comprises an array of bosses or protrusions.

7. The turf repair tool of claim 1, wherein the seed bed creation portion comprises a seed bed creation module which is removably attached to the body and/or wherein the seed dispensing portion comprises a seed dispensing module which is removably attached to the body.

8. The turf repair tool of claim 7, wherein the seed bed creation module and/or the seed dispensing portion is removably attached to the body by way of a screw attachment or a push fit arrangement.

9. The turf repair tool of claim 1, wherein the body and the seed bed creation portion and/or the seed dispending portion comprise a substantially unitary construction.

10. The turf repair tool claim 1, wherein the turf repair tool comprises a seed storage volume located within the body.

11. (canceled)

12. The turf repair tool of claim 10, wherein the seed dispensing portion comprises a seed receptacle which is moveable between a first position in which the predetermined amount of seed from the seed storage volume is collected in the seed receptacle and a second position in which the predetermined amount of seed is dispensed from the seed receptacle.

13.-15. (canceled)

16. The turf repair tool of claim 12, wherein the receptacle is biased towards the second position.

17. (canceled)

18. The turf repair tool of claim 12, wherein the seed dispensing portion comprises a hopper to direct seed from the seed storage volume towards the seed receptacle.

19. The turf repair tool of claim 1, wherein the seed dispensing portion comprises a shape corresponding or complementary to the shape of the seed bed creation portion.

20. (canceled)

21. The turf repair tool of claim 1, wherein the seed dispensing portion comprises a recess which acts as a wind shield when dispensing seed.

22. (canceled)

23. The turf repair tool of claim 21, wherein the shape of the recess permits or causes the seed to spread out over the seed bed when dispensed.

24.-25. (canceled)

26. The turf repair tool of claim 1, wherein the turf repair tool further comprises a sand dispensing portion which comprises an actuator configured to selectively dispense sand from a sand storage volume located within the body.

27.-31. (canceled)

32. A method of repairing turf, the method comprising creating a predetermined seed bed, wherein the seed bed is created and a predetermined amount of seed dispensed into the seed bed using a turf repair tool according to claim 1.

33. The method of claim 32, comprising pushing the first end of the turf repair tool into the turf to create the seed bed.

34. The method of claim 32, comprising selecting a seed bed creation module and/or a seed dispensing module appropriate for the turf to be repaired and/or the seed to be dispensed.

35.-36. (canceled)

37. The method of claim 32, comprising selecting a seed type appropriate for the turf to be repaired and storing the seed in a seed storage volume of the turf repair tool.

38. The method of claim 32, comprising dispensing coloured sand onto the turf from a sand dispensing portion of the turf repair tool after the seed has been dispensed into the seed bed.

39.-42. (canceled)

43. The method of claim 32, comprising repairing a pitch mark on the turf using a pitch fork or similar pitch mark repairer prior to creating the seed bed and dispensing the seed into the seed bed.
